(19) United States
(12) Patent Application Publication
(10) Pub. No.: US 2024/0349202 A1
(43) Pub. Date: Oct. 17, 2024

(54) SYSTEMS AND METHODS FOR REFERENCE SIGNALING DESIGN AND CONFIGURATION

(71) Applicant: ZTE Corporation, Shenzhen (CN)

(72) Inventors: Youjun HU, Shenzhen (CN); Bo DAI, Shenzhen (CN); Mengzhu CHEN, Shenzhen (CN); Jun XU, Shenzhen (CN); Qiujin GUO, Shenzhen (CN); Jianqiang DAI, Shenzhen (CN)

(73) Assignee: ZTE Corporation, Shenzhen (CN)

(21) Appl. No.: 18/733,347

(22) Filed: Jun. 4, 2024

Related U.S. Application Data
(63) Continuation of application No. PCT/CN2022/089118, filed on Apr. 25, 2022.

(51) Int. Cl. H04W 52/36; H04L 1/00; H04L 5/00; H04W 56/00; H04W 72/1273; H04W 72/231

(52) U.S. Cl. CPC H04W 52/365; H04L 1/0003; H04L 5/0051; H04W 52/367; H04W 56/0015; H04W 72/1273; H04W 72/231

(57) ABSTRACT

Presented are systems and methods for reference signaling design and configuration. A wireless communication device (e.g., UE) may detect at least one triggering condition for sending power headroom information for at least one downlink (DL) physical channel or signal. The wireless communication device may send the power headroom information responsive to the at least one triggering condition to a wireless communication node.

### CROSS-REFERENCE TO RELATED APPLICATION

This application claims the benefit of priority under 35 U.S.C. § 120 as a continuation of PCT Patent Application No. PCT/CN2022/089118, filed on Apr. 25, 2022, the disclosure of which is incorporated herein by reference in its entirety.

### TECHNICAL FIELD

The disclosure relates generally to wireless communications, including but not limited to systems and methods for downlink transmission related power control, and/or associated reference signaling design and configuration.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., UE) may detect at least one triggering condition for sending power headroom information for at least one downlink (DL) physical channel or signal. The wireless communication device may send the power headroom information responsive to the at least one triggering condition to a wireless communication node (e.g., a ground terminal, a base station, a gNB, an eNB, a repeater, or a serving node).

In some embodiments, the at least one triggering condition may comprise at least one of: the wireless communication node operating below a maximum output power, or a power of a received DL channel or signal is larger/lower than a threshold value, where the threshold value is determined at least by one of: a modulation and coding scheme (MCS) index table, a MCS, a modulation, another DL channel or signal, a downlink control information (DCI) signaling, a medium access control control element (MAC CE) signaling, or a higher layer signaling, or a defined downlink reference signal is absent or configured, or the corresponding configuration is present or absent, the defined downlink reference signal including a synchronization signal block (SSB), a primary synchronization signal (PSS), a secondary synchronization signal (SSS), or a channel state information reference signal (CSI-RS); or a DL channel or signal that is indicated, configured or scheduled with at least one of: a modulation order, a power, a code rate, a transmit block size (TBS), a port, a layer number, or one or more codewords, or the wireless communication device is in connected mode, or the wireless communication device receiving from the wireless communication node a DCI scrambled by a predetermined radio network temporary identifier (RNTI).

In some embodiments, the at least one triggering condition may comprise: receiving (by the wireless communication device) from the wireless communication node a signaling, the signaling comprising a downlink control information (DCI) signaling, a medium access control control element (MAC CE) signaling, or a higher layer signaling (e.g., RRC signaling). The signaling may comprise at least one of: a timer, a time window, or a periodicity. The wireless communication device may send the power headroom information according to the periodicity. The wireless communication device may receive the DL channel or signal with the periodicity for sending the power headroom information.

In some embodiments, the at least one triggering condition may comprise: the wireless communication node indicating that the wireless communication node is entering or in a network power saving mode. The network power saving mode may comprise: a sleep mode, the sleep mode comprising at least one of: a deep sleep mode, a light sleep mode, or a macro sleep mode, and/or a transition time, from a plurality of transition times corresponding to different network power saving modes.

In some embodiments, the at least one DL channel or signal may include at least one of: a physical downlink control channel (PDCCH), a demodulation reference signal (DMRS) for the PDCCH, a physical downlink shared channel (PDSCH), a DMRS for the PDSCH, a phase tracking reference signal (PT-RS) for the PDSCH, a synchronization signal block (SSB), a primary synchronization signal (PSS), a secondary synchronization signal (SSS), a DMRS for a physical broadcast channel (PBCH), a PBCH, a channel state information reference signal (CSI-RS), or a positioning reference signal (PRS). The triggering condition for sending power headroom information for PDCCH may comprise at least one of: (detecting/receiving) a PDCCH that may include a downlink control information (DCI) for sending power headroom information, scrambled by a radio network temporary identifier (RNTI), a PDCCH that can be configured by a higher layer signaling for sending power headroom information, with at least one of: a search space (SS) identifier (ID) or a control resource set (CORESET) ID, a PDCCH that can be transmitted in X symbols or slots or a time duration, wherein X or the time duration is predefined or configured by a higher layer or DCI signaling, or a PDCCH that is received with largest power, or is received before expiration of a timer, wherein the timer can be predefined or configured by a higher layer or DCI signaling.

In some embodiments, the triggering condition for sending power headroom information for PDSCH may comprise at least one of: (receiving/detecting) a PDSCH with a corresponding PDCCH that may (or is to) include a downlink control information (DCI) scrambled by a radio network temporary identifier (RNTI) for sending power headroom information, a PDSCH with a corresponding PDCCH that can be configured by a higher layer signaling for sending power headroom information, with at least one of: a search space (SS) identifier (ID) or a control resource set (CORESET) ID, a PDSCH with a corresponding PDCCH, or the PDSCH itself, that can be transmitted in X symbols or slots or a time duration, wherein X or the time duration can be predefined or configured by a higher layer or DCI signaling, a PDSCH with a corresponding PDCCH, or the PDSCH itself, that is received before expiration of a timer, wherein the timer can be predefined or configured by a higher layer or DCI signaling, a PDSCH that is scheduled using semi-persistent scheduling (SPS), a PDSCH that can carry a medium access control control element (MAC CE) signaling, or a PDSCH scheduled with a predetermined modulation order or a predetermined modulation and coding scheme (MCS) index table.

In some embodiments, the triggering condition for sending power headroom information for SSB may comprise: a SSB associated with a SSB index that is or can be indicated, predefined or configured by high layer signaling, a SSB associated with a SSB set that is or can be indicated, predefined or configured by higher layer signaling, a SSB in X symbols or slots or a time duration, wherein X or the time duration is or can be predefined or configured by a higher layer or DCI signaling, a SSB in a half frame, or a SSB in a period.

In some embodiments, the triggering condition for sending power headroom information for PRS may comprise: a PRS associated with an indicated, predefined or configured PRS resource set, a PRS associated with an indicated, predefined or configured PRS resource, a PRS in X symbols or slots or a time duration, wherein X or the time duration is or can be predefined or configured by a higher layer or DCI signaling, or one or more PRS in a period or cycle.

In some embodiments, the wireless communication device may receive a configuration via a higher layer signaling, a medium access control control element (MAC CE) signaling, a non-access stratum (NAS) signaling, or a signaling from the wireless communication node, wherein the configuration may indicate a period of time for sending the power headroom information. The wireless communication device may send the power headroom information during the period of time to the wireless communication node. The wireless communication device may send the power headroom information for the at least one DL physical channel or signal in the period of time to the wireless communication node. The period of time may comprise: one or more cycles for a resource or resource set of the at least one DL physical channel or signal; a time window; X symbols or slots or a time duration, wherein X or the time duration can be predefined or configured by a higher layer or DCI signaling; or X ms, us, frames or half frames, wherein X can be predefined or configured by a higher layer or DCI signaling.

In some embodiments, the power headroom information may comprise a value or (value) range or (value) set for a power headroom of the at least one DL physical channel or signal, wherein the value or range or set can be based on an absolute value, or an offset or relative value. In some embodiments, the power headroom information may comprise at least one of: an identifier (ID) of a control resource set (CORESET) or a CORESET pool, an ID of a serving cell, an ID of a bandwidth part (BWP), an index of a sub-band, a modulation and coding scheme (MCS), an indication of whether time division multiple access (TDMA) or frequency division multiple access (FDMA) can be implemented, a slot number, a frame number, an index of a synchronization signal block (SSB), a cycle position, an ID of a resource set or a resource of a PRS, CSI-RS, or SSB, an ID of a search space or a search spaces set, an identifier (ID) of a bandwidth part (BWP) set, wherein the BWP set may include one or more BWPs, a port number, or a set of port number.

The wireless communication device may send, to the wireless communication node, the power headroom information via at least one of: a radio resource configuration (RRC) signaling, a medium access control control element (MAC CE) signaling, a non access stratum (NAS) signaling, a channel state information (CSI) report, a physical uplink control channel (PUCCH) signaling, an uplink (UL) channel or signal that may carry a hybrid automatic repeat request (HARQ) acknowledgement (ACK) or negative acknowledgement (NACK) message, a physical uplink shared channel (PUSCH) transmission, or user equipment (UE) assistance information.

In some embodiments, a wireless communication device may receive a signaling from a wireless communication node. The signaling may comprise power information, or activation or deactivation information, or muting information, for at least one downlink (DL) physical channel or signal. The signaling may comprise a downlink control information (DCI) signaling or medium access control control element (MAC CE) signaling. The DL physical channel or signal may include at least one of: a physical downlink control channel (PDCCH), a demodulation reference signal (DMRS) for the PDCCH, a physical downlink shared channel (PDSCH), a DMRS for the PDSCH, or a phase tracking reference signal (PT-RS) for the PDSCH, a synchronization signal block (SSB), a primary synchronization signal (PSS), a secondary synchronization signal (SSS), a DMRS for a physical broadcast channel (PBCH), a PBCH, a channel state information reference signal (CSI-RS), or a positioning reference signal (PRS).

The power information may comprise: a value or a value range or a value set which can be based on an absolute value, or an offset or relative value. The MAC CE or DCI signaling to indicate the power information may comprise: a field to indicate power information for the at least one DL physical channel or signal. The MAC CE or DCI signaling may comprise: another field to indicate an identifier of a channel state information reference signal (CSI-RS) resource, an identifier of a CSI-RS resource set, a port number, a port number set, an identifier of a bandwidth part (BWP), or an identifier of a BWP set, for the at least one DL physical channel or signal.

In some embodiments, the MAC CE or DCI signaling may comprise: a joint coding (e.g., integration or combining of information) to indicate the power information and corresponding physical resources, wherein the corresponding physical resources may include at least one of: a channel state information reference signal (CSI-RS) resource, a set of CSI-RS resources, a list of CSI-RS resource sets, all CSI-RS in one or more bandwidth parts (BWPs), a CSI-RS resource corresponding to a port, CSI-RS resources corresponding to one or more ports, one wireless communication device, or a group of wireless communication devices.

The DCI signaling may comprise at least one of: a plurality of blocks at least some of which may have a same or different size, each of the blocks having a plurality of bits, or a plurality of indication/indicator at least some of which may have a same or different size, each of the blocks having a plurality of bits, wherein each of the blocks/indication/indicator may comprise at least one of: power information, activation or deactivation information, muting information, or an identifier (ID) of a CSI-RS resource, a set of CSI-RS resources, a BWP, a BWP set, or a port number. The DCI can be scrambled by a predefined or high layer configured radio network temporary identifier (RNTI); and/or DCI format 2_3, 2_4, or 2_6 can be reused for the DCI, or a new DCI format can be defined for the DCI. The DCI signaling may include a plurality of blocks, and a starting position of a first block of the plurality of blocks can be determined/indicated/specified by a medium access control control element (MAC CE) signaling, or a higher layer signaling.

In some embodiments, the at least one DL physical channel or signal may comprise a periodic or semi-persistent CSI-RS. The power information for a physical downlink shared channel (PDSCH) transmission, a channel state information reference signal (CSI-RS), a physical downlink control channel (PDCCH) transmission, a positioning reference signal (PRS) or a synchronization signal block (SSB), can be applied: after the MAC CE or DCI signaling (e.g., is received); k symbols, slots, half frames, frames, ms or us, after the MAC CE or DCI signaling (e.g., is received); or before a timer expires, wherein the timer can be defined, configured or indicated by the DCI signaling, a higher layer signaling, or the MAC CE signaling; or within X symbols or slots or a time duration, wherein X or the time duration can be predefined or configured by a higher layer or the DCI signaling or the MAC CE signaling.

In some embodiments, the signaling may comprise activation information which may comprise: an indication that the at least one DL physical channel or signal, or resources of the at least one DL physical channel or signal, may be (or is) received after activation, wherein the DL physical channel or signal may include at least one of: a channel state information reference signal (CSI-RS), or a synchronization signal block (SSB).

In some embodiments, the signaling may comprise deactivation information which may comprise: an indication that the at least one DL physical channel or signal, or resources of the at least one DL physical channel or signal, may not be (or is) received after deactivation, wherein the DL physical channel or signal may include at least one of: a channel state information reference signal (CSI-RS), or a synchronization signal block (SSB).

The signaling may comprise muting information which may comprise: an indication that the at least one DL physical channel or signal, or resources of the at least one DL physical channel or signal, may be (or is) muted after receiving the muting information, wherein the DL physical channel or signal may include at least one of: a channel state information reference signal (CSI-RS), or a synchronization signal block (SSB).

At least one aspect is directed to a system, method, apparatus, or a computer-readable medium of the following. A wireless communication node (e.g., a ground terminal, a base station, a gNB, an eNB, or a serving node) may receive power headroom information for at least one downlink (DL) physical channel or signal from a wireless communication device (e.g., UE). The power headroom information can be sent to the wireless communication node responsive to at least one triggering condition for sending the power headroom information.

In some embodiments, a wireless communication node may send a signaling to a wireless communication device. The signaling may comprise power information, or activation or deactivation information, or muting information, for at least one downlink (DL) physical channel or signals. The signaling may comprise a downlink control information (DCI) or medium access control control clement (MAC CE) signaling.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure.

FIG. 2 illustrates a block diagram of an example base station and a user equipment device, in accordance with some embodiments of the present disclosure.

FIG. 3 illustrates a data structure of an example power information for a physical downlink control channel (PDCCH) via a medium access control (MAC) control element (CE), in accordance with some embodiments of the present disclosure.

FIG. 4 illustrates a data structure of an example synchronization signal block (SSB), in accordance with some embodiments of the present disclosure.

FIG. 5 illustrates a flow diagram of an example method for downlink power control, in accordance with an embodiment of the present disclosure.

FIG. 6 illustrates a flow diagram of an example method for downlink power control, in accordance with an embodiment of the present disclosure.

### DETAILED DESCRIPTION

### 1. Mobile Communication Technology and Environment

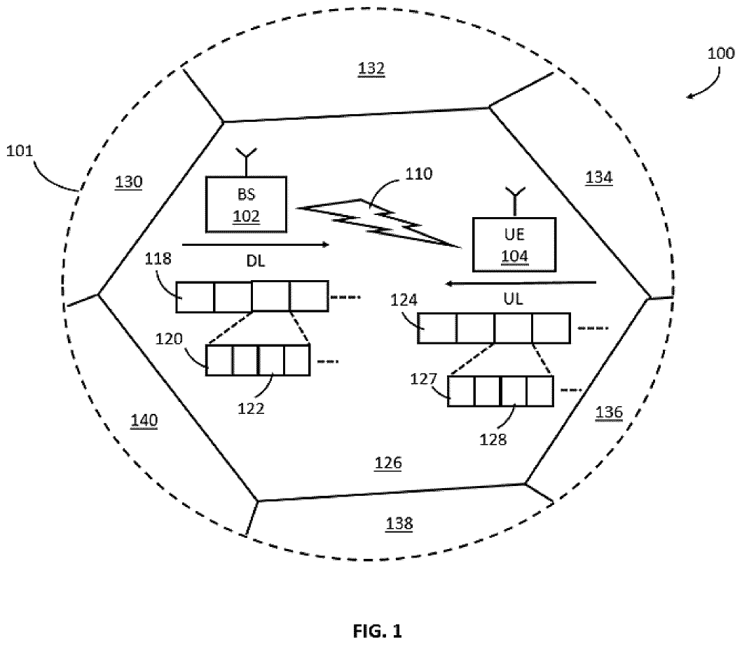

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

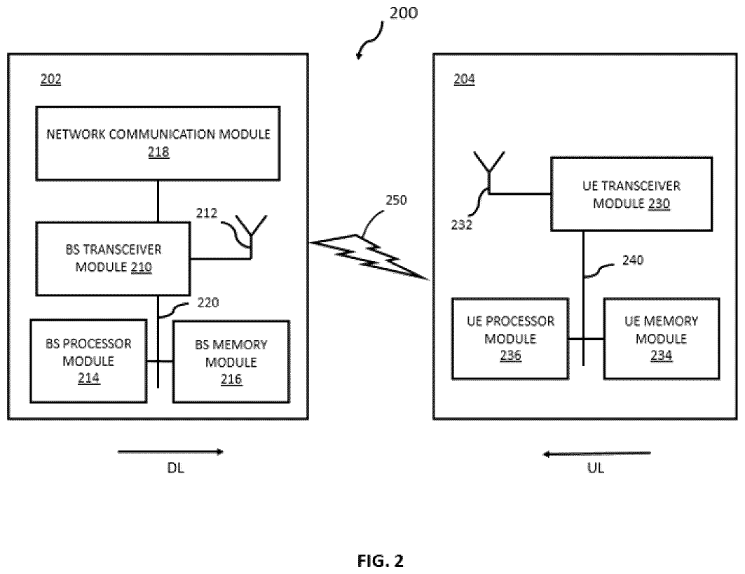

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Signaling Design and Configuration

Since a close-loop power control (e.g., with a feedback mechanism) may not be supported for downlink (DL), a base station (BS) cannot sense/monitor (or receive feedback on) whether a certain power allocation/adjustment can be accurate/appropriate in time. How a DL power allocation is adjusted may impact a BS' power consumption and a user equipment (UE)'s reception of downlink transmission(s). More specifically, maintaining a large/high transmit power at the BS can guarantee reception of the BS' transmission at the UE, while it may cause a power wastage/inefficiency of the BS since a UE may not need such high power transmission(s) to the UE. Keeping a low transmit power can help save BS power, while it may cause UE reception issue(s) and may result in repeated transmissions in response to the reception issue(s), which may increase power consumption for the UE and the BS. A method via a UE sending information to tell/inform a BS about information that can be used for performing a resource element (RE) power adjustment/adaptation for a downlink (DL) channel/signal, and/or the BS dynamically adjusting the power allocation for the DL channel/signal is presented. The systems and methods presented herein can include novel approaches for signaling design and configuration, e.g., associated with power control/adjustment.

A resource element (RE) power control dynamic range can be a difference between a power of an RE and an average RE power for a BS at maximum output power (e.g., P_{max,c,AC} or P_{max,c,TABC}) for a specified reference condition. For a BS of type 1-C, a requirement may apply at an antenna connector supporting transmission in an operating band. For BS of type 1-H, a requirement may apply at each TAB connector supporting transmission in a operating band. RE power control dynamic range can be shown in Table 1.

TABLE 1

| | |
|---|---|
| Modulation scheme | RE power control dynamic range (dB) |

| used on the RE | (down) | (up) |
|---|---|---|
| QPSK (PDCCH) | −6 | +4 |
| QPSK (PDSCH) | −6 | +3 |
| 16QAM (PDSCH) | −3 | +3 |
| 64QAM (PDSCH) | 0 | 0 |
| 256QAM (PDSCH) | 0 | 0 |
| 1024QAM (PDSCH) | 0 | 0 |

NOTE:
The output power per carrier may be less or equal to the maximum output power of the base station.

For a positioning reference signal (PRS), a field (e.g., dl-PRS-ResourcePower) may specify an average energy per resource element (EPRE) of resources elements that may carry the PRS in dBm that can be used for a PRS transmission. The UE may assume constant EPRE can be used for all REs of a given DL-PRS resource. For each downlink PRS resource configured, the UE may assume a sequence r(m) can be scaled with a factor β_{PRS} and can be mapped to resources elements (k,l)_{p,μ} according to

$${a}_{k , l}^{( p , μ )} = {β}_{P R S} r ( m )$$

$$m = 0 , 1 , …$$

$$k = m {K}_{comb}^{PRS} + ( ( {k}_{offset}^{PRS} + {k}^{′} ) mod {K}_{comb}^{PRS} )$$

$$l = {l}_{start}^{PRS} , {l}_{start}^{PRS} + 1 , … , {l}_{s t a r t}^{P R S} + {L}_{P R S} - 1$$

With respect to demodulation reference signal (DMRS) for physical downlink channel (PDSCH), a UE may assume a sequence r(m) can be scaled by a factor β_{PDSCH}^{DMRS} to conform with a specified transmission power and can be mapped to resource elements (k,l)_{p,μ} according to

$${a}_{k , l}^{( ρ , μ )} = {β}_{PDSCH}^{DMRS} {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

With respect to phase tracking reference signal (PT-RS) for physical downlink channel (PDSCH), a UE may assume that a PDSCH PT-RS can be scaled by a factor β_{PT-RS,i} to conform with a specified transmission power and can be mapped to resource elements (k,l)_{p,μ} according to

$${a}_{k , l}^{( p , μ )} = {β}_{P T - RS , i} {r}_{k}$$

In some embodiments, primary synchronization signal (PSS)/secondary synchronization signal (SSS)/physical broadcast channel (PBCH)/DMRS for PBCH may have a same RE power.

For a half frame with synchronization signal block (SSB) (SS/PBCH) blocks, a first symbol indexes for candidate SS/PBCH blocks can be determined according to a subcarrier spacing (SCS) of SS/PBCH blocks as follows, where index 0 may correspond to the first symbol of a first slot in a half-frame.

### Example Case A—15 kHz SCS

First symbols of candidate SS/PBCH blocks may have indices of {2, 8}+14·n. For operation without shared spectrum channel access and carrier frequencies smaller than or equal to 3 GHz, n can be 0 or 1. For operation without shared spectrum channel access and carrier frequencies within FR1 larger than 3 GHz, n can be 0, 1, 2, or 3. For operation with shared spectrum channel access, n can be 0, 1, 2, 3, or 4.

### Example Case B—30 kHz SCS

First symbols of candidate SS/PBCH blocks may have indices of {4, 8, 16, 20}+28·n. For carrier frequencies smaller than or equal to 3 GHz, n can be 0. For carrier frequencies within FR1 larger than 3 GHz, n can be 0 or 1.

### Example Case C—30 kHz SCS

First symbols of candidate SS/PBCH blocks may have indices of {2, 8}+14·n. For operation without shared spectrum channel access, paired spectrum operation, and carrier frequencies smaller than or equal to 3 GHz, n can be 0 or 1. For operation without shared spectrum channel access, paired spectrum operation, and carrier frequencies within FR1 larger than 3 GHz, n can be 0, 1, 2, or 3.

For operation without shared spectrum channel access, unpaired spectrum operation, carrier frequencies smaller than 1.88 GHz, n can be 0 or 1. For operation without shared spectrum channel access, unpaired spectrum operation, carrier frequencies within FR1 equal to or larger than 1.88 GHz, n can be 0, 1, 2, or 3. For operation with shared spectrum channel access, n can be 0, 1, 2, 3, 4, 5, 6, 7, 8, or 9.

### Example Case D—120 kHz SCS

First symbols of candidate SS/PBCH blocks may have indices of {4, 8, 16, 20}+28·n. For carrier frequencies within FR2, n can be 0, 1, 2, 3, 5, 6, 7, 8, 10, 11, 12, 13, 15, 16, 17, or 18.

### Example Case E—240 kHz SCS

First symbols of candidate SS/PBCH blocks may have indices of {8, 12, 16, 20, 32, 36, 40, 44}+56·n. For carrier frequencies within FR2-1, n can be 0, 1, 2, 3, 5, 6, 7, or 8.

### Example Case F—480 kHz SCS

First symbols of candidate SS/PBCH blocks may have indices of {2, 9}+14·n. For carrier frequencies within FR2-2, n can be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or 31.

### Example Case G—960 kHz SCS

First symbols of candidate SS/PBCH blocks may have indices of {2, 9}+14·n. For carrier frequencies within FR2-2, n can be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or 31.

In some embodiments, a UE may send a power adjustment/headroom information. The power adjustment/headroom information (e.g., power related assistance information) can be used/referred to by a BS to make a decision/determination to perform/implement a change/adjustment in transmission power (e.g., power level, and/or transmission/power pattern/variation over a period of time) of DL channels/signals (e.g., to cause/influence the BS to adjust power upwards/downwards). The power headroom information can indicate how much transmission power is over/beyond a level that is sufficient/needed for a UE to perform a successful reception. The power headroom information can include/represent/indicate an actual level of power of a channel/signal received at the UE, a level of received power that is adequate/needed for the UE, a difference/gap/margin between the aforementioned levels of power, an amount/range of power adjustment available to the BS, etc. Dynamic power control (initiated by the BS) can be used as a method for performing/implementing a change/adjustment in transmission power of DL channels/signals, and/or for performing/implementing a change/adjustment in transmission power of UL channels/signals (e.g., transmitted by the UE).

In some embodiments, explicit conditions or implicit conditions can be used for triggering the UE to send a power adjustment/headroom information (e.g., corresponding to implementation example 1). In some embodiments, specific/target DL channels/signals can cause/trigger a UE to send power adjustment/headroom information to the BS. In some embodiments, power adjustment/headroom information may specify detailed power adjustment/headroom data/metrics/values/ranges (e.g., corresponding to implementation example 3). In some embodiments, a UE may send a report, to a BS, including power adjustment/headroom information via a radio resource configuration (RRC) signaling, a medium access control control element (MAC CE) signaling, a non-access stratum (NAS), a physical uplink shared channel (PUSCH), a physical uplink control channel (PUCCH), a higher layer signaling, a hybrid automatic repeat request (HARQ) acknowledgement (ACK) or negative acknowledgement (NACK) message, a channel state information (CSI) report, a defined uplink signaling, or other UE assistance information (corresponding to implement example 4). In some embodiments, a UE may send such a report to a BS according to a certain timing/schedule (e.g., corresponding to implement example 5). Besides (or independent of) the UE report which may include the power adjustment/headroom information, a dynamic DL power control approach can be implemented to adjust a DL channel/signal power (e.g., corresponding to implementation example 6). Various features in the following implementation examples are provided by way of illustration, and it is fully contemplated that these features can be used in any combination and/or order in various other implementations.

### Implementation Example 1

A UE may detect at least one triggering condition for sending power headroom information for at least one downlink (DL) physical channel or signal. The UE may send the power headroom information to a BS, responsive to the at least one triggering condition.

One or more conditions for triggering the report may include at least one of: the wireless communication node operating below a maximum/threshold output power (e.g., for FR1, BS may not be at maximum output power), according to an indication from the BS for instance; the wireless communication device receiving from the wireless communication node an indication of a time window or timer (e.g. for scheduling the sending of the report); or a defined downlink reference signal being absent or configured, or a corresponding configuration being present or absent. The defined downlink reference signal may include a synchronization signal block (SSB), a primary synchronization signal (PSS), a secondary synchronization signal (SSS), or a channel state information reference signal (CSI-RS). One or more conditions for triggering the report may include at least one of: the wireless communication device is in a connected mode or entering a connected mode.

In some embodiments, a trigger condition may include the UE receiving from the BS a time window or timer. For example, before the timer expires, the UE may send the power adjustment/headroom information for a physical channel/signal. As another example, in response to a configured time window, the UE may send the power adjustment/headroom information for a physical channel/signal during the configured time window. As another example, in response to a configured time window, the UE may send the power adjustment/headroom information according to a physical channel/signal transmission during the configured time window.

In some embodiments, a trigger condition may include that a downlink reference signal is determined to be absent. For instance, if the defined downlink reference signal is expected (e.g., configured) but is absent or undetected by the UE, possibly due to insufficient transmission power, the UE may send a report to cause the BS to perform power adjustment on subsequent DL transmission(s). For example, a trigger condition may include that a SSB is determined to be absent (e.g. undetected, or unsuccessfully decoded) in a bandwidth part (BWP). In another example, a channel status information reference signal (CSI-RS) can be absent in a PDSCH scheduling, or a DMRS or any other DL RS can be absent.

In some embodiments, a trigger condition may include that the UE is in/entering a connected mode (or exiting an inactive mode, or an idle mode). For example, when a UE is in connected mode (and able to receive DL transmissions), the UE only can send the power headroom information to the BS. One or more of the aforementioned conditions can independently or combine to trigger the UE sending power adjustment/headroom information.

In some embodiments, the at least one triggering condition may comprise at least one of: the wireless communication device receiving from the wireless communication node a higher layer signaling (RRC signaling may include MAC CE signaling and RRC signaling); the wireless communication device receiving from the wireless communication node a downlink control information (DCI) signaling; the wireless communication device receiving from the wireless communication node a DCI scrambled by a predetermined radio network temporary identifier (RNTI) (e.g., C-RNTI, MCS-C-RNTI, P-RNTI, SI-RNTI); or the wireless communication device receiving from the wireless communication node; or a parameter or feature indicated, enabled or disabled via a DCI or higher layer signaling.

In some embodiments, when the BS enters a power saving mode, this may be a trigger condition for sending power headroom information to the BS. The network power saving mode may comprise: a sleep mode, the sleep mode comprising at least one of: a deep sleep mode, a light sleep mode, or a macro sleep mode; and/or a transition time, from a plurality of transition times corresponding to different network power saving modes; and/or output power ranges/power consumptions from a plurality of output power ranges/power consumption levels corresponding to different network power saving modes

For example, different power saving modes for a BS may correspond to different output power ranges/power consumptions. When the BS enters a mode corresponding to the maximum output power, the UE may report power adjustment/headroom information, so that the BS may potentially reduce the transmission power level (e.g., power allocation). When the BS enters a mode which may correspond to a lower output power than the maximum, the UE may not need to report power adjustment/headroom information, in some embodiments. A defined power saving mode for the BS can be a condition to trigger the UE sending the power headroom information. Another example, the network power saving mode may comprise: a sleep mode, the sleep mode comprising at least one of: a deep sleep mode, a light sleep mode, or a macro sleep mode. The network power saving mode may comprise a transition time, that may be selected/implemented from a plurality of transition times corresponding to different network power saving modes (e.g., a deep sleep mode, a light sleep mode, or a macro sleep mode). Another example, when the gNB indicates it is being a NW power saving mode, the UE may send the power headroom information, where different power saving mode may correspond to different transition times.

In some embodiments, when the UE receives a high/higher layer signaling (e.g., system information (SI) information, RRC, NAS, or MAC CE) from the BS, a trigger condition for sending information (e.g., power headroom information) to be used by the BS may be triggered. The high/higher layer signaling may indicate which DL channel/signal, including SSB, PSS, SSS, DMRS, PBCH, PRS, PDCCH, or PDSCH, the information can be applied to. For example, a bitmap method can be used, where each bit can be used for each channel/signal. For another example, a parameter or field can be configured and/or used to indicate which channels/signals may need the UE to send the power adjustment/headroom information.

In some embodiments, when the UE receives a downlink control information (DCI) signaling having a defined triggering indication from the BS, a trigger condition for sending information to be used by the BS may be triggered. The DCI signaling field may contain one or more bits (e.g., 1 bit, 2 bit, 3 bits, or 4 bits).

### Example 1—1 Bit

One bit to indicate whether the power adjustment/headroom information may be needed for the DL channel/signal. One bit can be used to indicate whether the PDSCH transmission power may need/use the power adjustment report or not, or this bit can be used to indicate whether PDSCH transmission power (if there is no corresponding PDCCH), or PDCCH transmission power (if there is no PDSCH), or PDCCH and PDSCH transmission power(s) may need/use (e.g., be configured using) the adjustment information report.

### Example 2—2 Bits

Two bits to indicate whether PDCCH and/or PDSCH transmission power(s) may need (e.g., be configured based on) the adjustment information. For example, two bits in a bitmap can be used, where 1 bit can be for a PDCCH and 1 bit can be for a PDSCH. The following states can be indicated: only PDCCH transmission power may need/use the power adjustment/headroom information to perform power adjustment, only PDSCH may need/use power adjustment/headroom information to perform power adjustment, or PDCCH and PDSCH transmission power(s) may need/use power adjustment/headroom information.

### Example 3—3 Bits

Three bits may indicate different channels/signals that may need or rely on a UE to send power adjustment/headroom information to aid the BS to perform power adjustment. The channels/signals may include: a PDCCH, a PDSCH, and/or a SSB. In some embodiments, the channels/signals may include: a PDCCH, a PDSCH, and/or a PRS. In certain embodiments, the channels/signals may include: a PDSCH, a SSB, and/or a PRS.

### Example 4—4 Bits

Four bits may indicate whether PDCCH, PDSCH, SSB, or CSI-RS transmission power(s), or PDCCH, PDSCH, SSB, or PRS may need or rely on the UE to send the power adjustment/headroom information to aid the BS to perform power adjustment. The UE may receive the MAC CE from the BS. The UE may send the power adjustment/headroom information to the BS, e.g., in response to the MAC CE. In some embodiments, the UE may receive the following indication: which DL channels/signals may need the UE to send the power adjustment/headroom information; which slot/symbol may need the UE to send the power adjustment/headroom information for a channel/signal.

In some embodiments, when the UE receives a DCI signaling where the DCI is scrambled by a radio network temporary identifier (RNTI) (e.g., C-RNTI, MCS-C-RNTI, P-RNTI, SI-RNTI), a trigger condition for sending information may be used. When the UE receives a DCI scrambled by X-RNTI (e.g., Cell-RNTI, modulation and coding scheme cell RNTI (MCS-C-RNTI), configured scheduling RNTI (CS-RNTI), or any defined RNTI), the DCI signaling may indicate that the UE is to send the power adjustment/headroom information. For example, a SPS scheduling can be a condition to trigger the UE to send the power adjustment/headroom information (e.g., when a (predetermined/BS configured/DCI indicated/high layer configured) MCS table for PDSCH is used, or when a (predetermined/BS configured/DCI indicated/high layer configured) modulation order is used). For example, when 64 QAM (Modulation Order=4) or 256 QAM (Modulation Order=8) is used, the UE may send the power adjustment/headroom information. For example, when a defined MCS index for PDSCH is used, the UE may be triggered to send the power adjustment/headroom information.

When a parameter or a feature is configured, enabled or disabled by a DCI or higher layer signaling, a trigger condition for sending information to the BS may be triggered. For example, when cross slot scheduling is enabled or not enabled, the UE may send the power adjustment/headroom information.

### Implementation Example 2

In some embodiments, a channel/signal may cause/need a UE to send information (e.g., power headroom information) to a BS. The UE may be triggered by a condition to send the power headroom information for the (target) channel/signal. The following may define which channels/signals can be targeted for the UE to report the power headroom information. In this disclosure, the power headroom information sometimes may be simply referred as information.

When the UE receives an X-RNTI (e.g., C-RNTI, MCS-C-RNTI, P-RNTI, or SI-RNTI) scrambled DCI, the PDCCH/corresponding PDSCH may be targeted (e.g., the power headroom information can be based on a target channel/signal, e.g., the channel is a PDSCH), and the UE may send the information (e.g., power headroom information). The power headroom information can be sent for a particular channel/signal (e.g., PDSCH). When/Once the specific channel is targeted, the power headroom information sent by the UE can be based on the targeted channel. In some embodiments, when the UE receives a high layer signaling indicated for a PDCCH with SS ID and/or control resource set identity (CORESET ID), or for the corresponding PDSCH, the PDCCH/corresponding PDSCH may be targeted and the UE may send the information. In some embodiments, when the UE receives a specific SS for a PDCCH, including a common search space (CSS), UE specific search space (USS), or corresponding PDSCH, the PDCCH/corresponding PDSCH may be targeted, and the UE may send the information. The SS can be pre-determined/high layer configured/BS configured, and the SS may include a CSS and/or a USS. In certain embodiments, when the UE receives the DL channels/signals in the symbol(s)/slot(s)/time window/a period of time or before a timer expires, the DL channels/signals may be targeted, and the UE may (be caused/triggered to) send the information. In some embodiments, after the UE receives the MAC CE which can be used to trigger UE into sending the information for DL channels/signals, the UE may send the information.

For a PDCCH (that can be transmitted to a UE), an X-RNTI scrambled DCI may need/cause/trigger the UE to send a power adjustment/headroom information for a PDCCH. For example, an X-RNTI may include at least one of C-RNTI, MCS-C-RNT. For example, an X-RNTI may include at least one of C-RNTI, MCS-C-RNTI, P-RNTI, or SI-RNTI. A defined RNTI can be used to scramble the DCI, which can be used to indicate the power allocation/adjustment, or to trigger the UE to send the information.

A high/higher layer indicated PDCCH with a SS ID and/or a CORESET ID may need/cause/trigger the UE to send power adjustment/headroom information. In a SearchSpace IE, a new field can be defined to indicate whether the PDCCH may need the power adjustment/headroom information. In some embodiments, a RRC signaling may indicate that the power adjustment/headroom information is to apply to a SS and or a CORESET.

For a PDCCH in a pre-determined search space set or search space set/group, a pre-determined search space set may include at least one of UE-specific search space (USS) or type 3 common search space (CSS). For example, the pre-determined SS may include a type 2 CSS or USS. The UE can send the corresponding power adjustment/headroom information under such a condition. The PDCCH in a symbol(s)/slot(s)/time window or before a timer expires may need/cause/trigger the UE to send the information.

For a physical downlink shared channel (PDSCH), the above cases for PDCCH can be used for the PDSCH. An X-RNTI scrambled DCI (e.g., CS-RNTI) may be used to schedule a PDSCH. Such a PDSCH is targeted and the UE may send the information. A high/higher layer indicated PDCCH may include a SS ID and/or a CORESET ID. A PDSCH scheduled by such a PDCCH may need/cause/trigger the UE to send the information. A specific SS for a PDCCH may include a CSS and/or a USS. The PDSCH scheduled by such a PDCCH is targeted and the UE may send the information. A high layer/DCI indicated symbol(s)/slot(s)/time window or timer expiration may need/cause/trigger the UE to send the information. A PDSCH in such symbol(s)/slot(s)/time window or occurring/received before the timer expires, is targeted and the UE may send the information. The high/higher layer/DCI may contain a triggering information for a UE to send for a DL channel/signal.

For a SPS scheduling, such a PDSCH or the first PDSCH may be targeted, and a UE may (accordingly, or in response) send the information (e.g., power adjustment/headroom information). For a UE specific PDSCH scheduling, such a PDSCH may be targeted, and the UE may send the information. For a UE specific PDSCH scheduling in a slot, such a PDSCH may be targeted, and the UE may send the information. For a UE specific PDSCH scheduling (if the PDSCH scheduling delay is larger than X), such a PDSCH may be targeted, and the UE may send the information.

For a PDSCH scheduling with acknowledge (ACK) or negative acknowledgement (NACK) feedback, this PDSCH scheduling may need/trigger/cause the UE to send the information. If the UE receives the PDSCH successfully and feedbacks an ACK, the UE may send the information together with the ACK. In some embodiments, if the UE receives the PDSCH unsuccessfully and feedbacks a NACK, the UE may (be triggered to) send the information together with the NACK. For a PDSCH containing MAC CE for triggering a UE to send the information, the PDSCH may be targeted and the UE may send the information. For a PDSCH triggered by MAC CE, the PDSCH may need/cause/trigger the UE to send the information. For example, the MAC CE may include triggering information to trigger a UE to send the information. For example, the PDSCH can be the first PDSCH transmission or the n-th PDSCH transmission.

For a synchronization signal block (SSB), the SSB may correspond to a starting symbol for all the n. For example, for each n, the last SSB may correspond to the last starting symbol in {2, 8}+14·n. The SSB may be targeted, and the UE may send the information. For example, the worst/best SSB may be targeted and the UE may send the information. In some embodiments, a SSB in a cycle may be targeted and the UE may send the information. For example, for each SSB cycle, the last SSB may be targeted, and the UE may send the information. For example, for each SSB cycle, the worst/best SSB may be targeted, and the UE may send the information. For example, for each SIB1 cycle, the last/worst/best SSB may be targeted, and the UE may send the information. In some embodiment, the triggering condition for sending power headroom information for SSB may comprise: (the UE receiving) a SSB associated with a SSB index that can be indicated, predefined or configured (e.g., specific one that may require/trigger the UE to send the information) by high/higher layer signaling, a SSB associated with a SSB set that can be indicated, predefined or configured by higher layer signaling, a SSB in X symbols or slots or a time duration, wherein X or the time duration can be predefined or configured by a higher layer or DCI signaling, a SSB in a half frame, or a SSB in a period.

For a positioning reference signal (PRS), a PRS resource set may be targeted, and a UE may send the information. The UE may send the information for the resource set based on a period of a PRS transmission (e.g., a cycle, a defined time window, or a timer). In some embodiments, a PRS resource may be targeted, and a UE may send the information. The UE may send the information based on a period of a PRS transmission (e.g., a cycle, a defined time window, or a timer). The UE may send the information based on last PRS in a cycle, or best/worst PRS of power. In some embodiments, the triggering condition for sending power headroom information for PRS may comprise: (the UE receiving) a PRS associated with an indicated, predefined or configured (e.g., specific one that may require/cause the UE to send the information) PRS resource set, a PRS associated with an indicated, predefined or configured (e.g., specific one that may require the UE to send the information) PRS resource, a PRS in X symbols or slots or a time duration, wherein X or the time duration can be predefined or configured by a higher layer or DCI signaling, or one or more PRS in a period or cycle.

The power headroom information that a UE sends can be according to DL channels/signals (occurring/scheduled) in a specific period of time. For example, the UE may send the information according to a PDSCH received within X slots (or other time units). X slots can be configured/indicated/defined by higher layer/MAC CE/NAS/BS. Depending on the information in the X slots, the content of a report may be different. For example, the UE may send the information according to the DL channels/signals (occurring/scheduled/received) in a period of time. The information may contain an average/maximum/minimum power adjustment value. The slot number and/or frame number or resource ID of a CSI-RS or a PRS for the DL channels/signal for the corresponding average/maximum/minimum power adjustment value can be sent as part of the information. For example, the UE may send information which may include the power adjustment information for a modulation order. For example, the UE may send information which may include the power adjustment information for a SSB index/beam direction.

### Implementation Example 3

The power adjustment/headroom information can be used to tell/inform/aid the BS to perform adjustment on the DL power allocation for corresponding channels/signals. The power adjustment information may at least include a power adjustment value or range or value set (e.g., a set of values). The value or range or value set may be based on an absolute value, or an offset, or relative value. For example, the value or range or set can be based on an absolute power value, {x1, x2} (e.g., {−60, 50}), step size can be 1 dB, which can be used for the scenario of dynamic DL power allocation. In certain embodiments, the value or range can be based on a power offset of a SSB, {y1, y2, y3, y4} (e.g., {−6, −3, 0, 3}), where step size can be 3 dB.

If a power adjustment is based on an offset, the offset can be a type of power difference. For example, the offset can be based on SSB power. In some embodiments, the power adjustment for a DL channel/signal can be based on a power of a scheduled DL channel/signal. For example, the power adjustment information for PDSCH can be used to adjust the power of a next PDSCH transmission (e.g., current PDSCH power+adjustment=future PDSCH power). The power of a scheduled DL channel/signal may mean/represent the transmit power from the BS. In some embodiments, the power adjustment value or range can be determined by a target block error ratio (BLER). For example, under different target BLERss, the power adjustment value or range or set can be different.

A higher layer parameter may configure a step size, a starting value, an ending value, and/or a range. A downlink control information (DCI) may indicate a step size, a starting value, an ending value, and/or a range. For example, the higher layer parameter can configure or the DCI can indicate that the range is (z1, z2) and the step size is z. In certain embodiments, the DCI may indicate that the range can be (z1, z2) and (z3, z4), and the DCI can indicate one of the two sets. In some embodiments, the higher layer can configure the range to be (z1, zn) and step size to be z, and the DCI can indicate a sub-set of (z1, zn). In some embodiments, the higher layer can configure the range to be (z1, zn), and the DCI may indicate a sub-set of (z1, zn).

In some embodiments, the power headroom/adjustment information may comprise at least one of: an identifier (ID) of a control resource set (CORESET) or a CORESET pool, an ID of a serving cell, an ID of a bandwidth part (BWP), an index of a sub-band, a modulation and coding scheme (MCS), an indication of whether time division multiple access (TDMA) or frequency division multiple access (FDMA) is implemented, a slot number, a frame number, an index of a synchronization signal block (SSB), a cycle position, an ID of a resource set or a resource of a PRS, CSI-RS, or SSB, an ID of a search space set, or an identifier (ID) of a bandwidth part (BWP) set, wherein the BWP set includes one or more BWPs.

### Implementation Example 4

A UE may send, to a BS, the information via at least one of: a radio resource configuration (RRC) signaling, a medium access control control element (MAC CE) signaling, a non access stratum (NAS) signaling, a channel state information (CSI) report, a physical uplink control channel (PUCCH) signaling, an uplink (UL) channel or signal that carries a hybrid automatic repeat request (HARQ) acknowledgement (ACK) or negative acknowledgement (NACK) message, or a physical uplink shared channel (PUSCH) transmission.

In some embodiments, a UE may send the information via a RRC signaling to a BS. The RRC IE for the power headroom information report may include at least one of the following information: a carrier/serving cell ID, a report configuration ID (e.g., PDSCH), a BWP ID (e.g., sub-band), a MCS, a channel information for report (e.g., PDCCH, PDSCH, PBCH, or PRS), a report configuration type (e.g., periodic, semipersistent, or aperiodic), a beam information/SSB information if this report is for PBCH, a CORESET ID/SS ID if this report is for PDCCH, or power adjustment/headroom information.

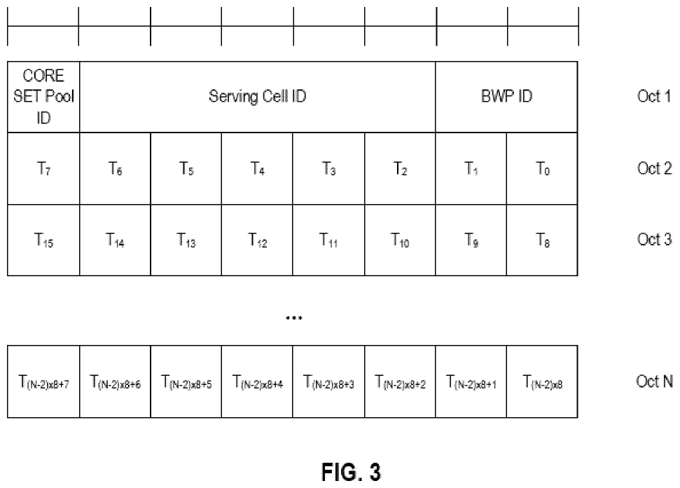

In some embodiments, a UE may send the information via a MAC CE signaling to a BS. The UE may select a physical channel or signal to report a power headroom information. The gNB can configure a corresponding physical channel or signal which may require a report from the UE to be sent via a system information block (SIB). The power information for a PDCCH in a MAC CE may include at least one of the following: a CORESET ID/CORESET pool ID, a serving cell ID, a BWP ID, or a power adjustment/headroom. FIG. 3 illustrates a data structure including an example power headroom information for a PDCCH via a MAC CE. In some embodiments, the power headroom information for a PDSCH, included in a MAC CE may include at least one of the following: a modulation and coding scheme (MCS), a time division multiple access (TDMA), a frequency division multiple access (FDMA), a serving cell ID, a BWP ID, or a power adjustment/headroom. In some embodiments, the power information for a PBCH in a MAC CE may include at least one of the following: a SSB index/cycle position, a serving cell ID, a BWP ID, or a power adjustment/headroom.

In certain embodiments, the information for PDCCH/PDSCH/PBCH can be reported via a MAC CE signaling. The MAC CE signaling may include at least one of the following information: a bitmap for a PDCCH/PDSCH/PBCH or one of PDCCH/PDSCH/PBCH, a serving cell ID, a BWP ID, or a power adjustment/headroom. A field in a MAC CE can have content that is determined according to an enabling of PDCCH/PDSCH/PBCH. For example, if a report is for a PDCCH, the field may include a CORESET ID information. If a report is for a PDSCH, the field may include MCS/TDMA/FDMA information. If a report is for a PBCH, the field may include a SSB index or other SSB related information.

In some embodiments, a UE may send the information via a high/higher layer signaling (e.g., RRC, MAC CE, NAS) to a BS. For a PRS, the power adjustment/headroom information can be reported via a NAS. At least one of following information may be included in an IE via higher layer signaling: a PRS resource set ID, a positioning frequency layer, a PRS resource ID, a position of a cycle or a number of a cycle, a physical cell ID (PCI), a cell ID, or carrier information. In some embodiments, the power adjustment/headroom information can be reported via a RRC signaling. At least one of following information may be included in a RRC IE: a carrier/serving cell ID, a report configuration ID, a PDSCH position (e.g., a slot number and/or a frequency position), a CORESET ID, a BWP ID (e.g., sub-band), a MCS, a channel information for report (e.g., PDCCH, PDSCH, PBCH, or PRS), a report configuration type (e.g., periodic, semi-persistent, or aperiodic), a beam information/SSB information if the report is for PBCH, a CORESET ID/SS ID if the report is for PDCCH, or a power adjustment/headroom information.

In some embodiments, a UE may send the information via a HARQ ACK/NACK to a BS. The UE may send the information via a common PUCCH resource which may be configured by pucch-ResourceCommon. For example, one bit in uplink control information (UCI) information bits can be used. The bit can indicate power adjustment/headroom for a SSB, PRS, or PDCCH/PDSCH associated with a CSS. The power adjustment value can be +3 dB-3 dB or +1 dB-1 dB. The PUCCH may comprise a PUCCH for msg4 or when pucch-config is not configured for initial BWP in rrcConnectionSetup. For example, additional pseudo-random sequence can be used to indicate the power adjustment information. Whether to send the power adjustment/headroom information may be determined by a SIB or high layer parameter. Which channels/signals to which the power adjustment/headroom information can applied may be determined by a SIB or higher layer parameter.

The UE may send the information via a dedicated PUCCH resource. At least a one-bit power adjustment/headroom information can be added to UCI information bits (via multiplexing, joint coding, separate bit sequence, separate part, scheduling request (SR), or channel state information (CSI)). When more than one bit of power adjustment/headroom information is sent, PUCCH format 0 and 1 cannot be used. Other PUCCH formats can be considered. A configuration about the power adjustment/headroom information can be indicated by a DCI or high layer parameter (e.g., PUCCH-Config). In certain embodiments, step size can be 3 dB, 1 dB, 0.5 dB, and so on. The number of bits can be 1, 2, 3, 4, 5, 6, 7, 8 bits. The power adjustment value/range can be based on ss-PBCH-BlockPower. Whether PDCCH and/or PDSCH is targeted and need/trigger/cause the UE to send the information can be indicated by the DCI or higher layer parameter. The DCI signaling may comprise: a joint coding to indicate the power information and corresponding physical resources, wherein the corresponding physical resources may include at least one of: a channel state information reference signal (CSI-RS) resource, a set of CSI-RS resources, a list of CSI-RS resource sets, all CSI-RS in one or more bandwidth parts (BWPs), a CSI-RS resource corresponding to a port, CSI-RS resources corresponding to one or more ports, one wireless communication device, or a group of wireless communication devices.

In some embodiments, a UE may send the information via a CSI report to a BS. In CSI-ReportConfig, a signaling/field can be defined (e.g., cri-PowerAdjustment, ssb-Index-PowerAdjustment). The field may contain a power range or a set of offset values (e.g., {−50, 60}, {−6 dB, −3 dB, 0 dB, 3 dB}). The UE may send the information included in the CSI report via a PUCCH/PUSCH. The conditions may comprise any one of the following: the UE can be configured with a CSI-ReportConfig with the higher layer parameter reportQuantity set to “cri-RSRP” or “ssb-Index-RSRP”, the UE can be configured with a CSI-ReportConfig with the higher layer parameter reportQuantity set to “cri-SINR” or “ssb-Index-SINR”, or the UE sending the information can be triggered by DCI/high layer/MAC CE together with an aperiodic/semi-persistent/periodic channel state information reference signal (CSIRS) report.

For example, the information can be triggered by a DCI indication and included in an aperiodic CSI report. A configuration for the power adjustment information can be configured by a higher layer signaling. A DCI can indicate a selection of power adjustment/headroom value/range. For example, the information can be triggered by a higher layer configuration and included in a periodic CSI report. The configuration for the power adjustment information can be configured by a higher layer signaling/configuration. For example, the information can be triggered by a MAC CE signaling and included in a semi-persistent CSI report. The configuration for the power adjustment information can be configured by a MAC CE signaling.

In some embodiments, in an idle/inactive mode, a UE can send the power

adjustment/headroom information via msg1/msg3/PUCCH for msg4. The UE can send the power adjustment/headroom information via quality metrics corresponding to a DL received signal time difference (RSTD) and a UE Rx-Tx time difference measurements (e.g., NR-TimingQuality). The UE can send the power adjustment/headroom information via UE assistance information.

### Implementation Example 5

In some embodiments, a MAC CE may be sent after a last/best/worst PRS/SSB. For a SSB, the MAC CE may be sent out before the end of a specific period. For example, the MAC CE can be sent at (e.g., start or end of) x+k symbols, where x can be the ending symbol of the last SSB in a period. The SSB may have a corresponding starting symbol and n. For a PRS, the MAC CE may be sent out before a specific period ends. For a PRS, the MAC CE may be sent after a best/worst PRS is occurred/received, with a timing relationship/delay (e.g., n+k).

In some embodiments, the MAC CE can be sent according to a timing relationship with a PUCCH. For a PDCCH/PDSCH, the MAC CE can be sent after UE receives a PDCCH/PDSCH. The timing relationship can be the same with the PUCCH. For example, the MAC CE can be sent before the start of the PUCCH, (offset) by k symbols/slots. For example, the MAC CE can be sent after the start of PUCCH, (offset) by k symbols/slots. For example, the MAC CE can be carried in a PUCCH/PDCCH/PDSCH/higher layer signaling.

The MAC CE can be sent with a relationship with a SSB/SSB cycle/PRS/PRS cycle. For example, the MAC CE can be sent after a SSB/PRS, (offset) by k symbols/slots. For example, the MAC CE can be sent after last SSB/PRS of a cycle k symbols/slots. After k symbols/slots has elapsed from a triggering event, the UE may send the information. The triggering event/method may include a MAC CE triggering, a DCI triggering, a high layer triggering, a BS triggering, or conditions triggering.

### Implementation Example 6

In some embodiments, a wireless communication device may receive a signaling from a wireless communication node. The signaling may comprise power information, or activation or deactivation information, or muting information, for at least one downlink (DL) physical channel or signals. The signaling may comprise a downlink control information (DCI) signaling or medium access control control element (MAC CE) signaling. The DL physical channel or signal may include at least one of: a physical downlink control channel (PDCCH), a demodulation reference signal (DMRS) for the PDCCH, a physical downlink shared channel (PDSCH), a DMRS for the PDSCH, or a phase tracking reference signal (PT-RS) for the PDSCH, a synchronization signal block (SSB), a primary synchronization signal (PSS), a secondary synchronization signal (SSS), a DMRS for a physical broadcast channel (PBCH), a PBCH, a channel state information reference signal (CSI-RS), or a positioning reference signal (PRS).

The power information may comprise a value or a value range or a value set which is based on an absolute value, or an offset or relative value. For example, the value can be absolute value, or an offset or relative value. For example, the value set can be a set of absolute values, or an offset values or relative values. For example, the value range can be based on absolute values, or an offset values or relative values. In some embodiments, the MAC CE or DCI signaling to indicate the power information may comprise: a field to indicate power information for the at least one DL physical channel or signal. For example, N bits can be used for indicating the power information. Another field also can be used to indicate an identifier of a channel state information reference signal (CSI-RS) resource, an identifier of a CSI-RS resource set, a port number, a port number set, an identifier of a bandwidth part (BWP), or an identifier of a BWP set, for the at least one DL physical channel or signal.

A joint coding field in the MAC CE or DCI signaling may indicate the power headroom information and corresponding physical resources. The corresponding physical resources may include at least one of: a channel state information reference signal (CSI-RS) resource, a set of CSI-RS resources, a list of CSI-RS resource sets, all CSI-RS in one or more bandwidth parts (BWPs), a CSI-RS resource corresponding to a port, CSI-RS resources corresponding to one or more ports, one wireless communication device, or a group of wireless communication devices.

The DCI signaling may comprise at least one of: a plurality of blocks at least some of which may have a same or different size, each of the blocks having a plurality of bits, or a plurality of indication/indicator at least some of which may have a same or different size, each of the blocks having a plurality of bits, wherein each of the blocks/indication/indicator may comprise at least one of: power information, activation or deactivation information, muting information, or an identifier (ID) of a CSI-RS resource, a set of CSI-RS resources, a BWP, a BWP set, or a port number or a set of port number. For example, each block may contain N bits, where N>=1.

For a physical downlink control channel (PDSCH), a power for the PDSCH can be determined by a downlink control information (DCI) field. The DCI field can be used to indicate a DL power allocation for a PDSCH/DMRS. The DCI field may comprise a power offset based on a SS/SSB. A field with X bits to indicate the PDSCH power based on the SSB power. For example, X can be 2 bits and the corresponding range can be {db−3, db0, db3, db6}, or {db−3, db0, db3, db−6}. The db−3 may indicate that the PDSCH RE power can be 3 db lower than the SSB. The DCI field may comprise a power scale factor based on a SS/SSB. A power scale factor based on (or applied to) a SSB power can be used to indicate a PDSCH power. For example, the scale factor can be 2 bits and can be configured with range {½, 1, 2, 4}. The PDSCH power may be {½, 1, 2, 4} times the SSB power. The DCI field may comprise an absolute power allocation. An absolute power allocation may include a value/range for PDSCH/DMRS for PDSCH/PT-RS for PDSCH. For example, the value can be from the range {−50, 60}, and the step size can be 1. If the field is present, the condition in implementation example 1 can be satisfied.

For a PDCCH, the power for a future PDCCH can be determined by a DCI field. The DCI field can be used to indicate the DL power allocation for a PDCCH/DMRS. The DCI field may comprise a power offset based on a SS/SSB, a power scale factor based on SS/SSB, or an absolute power allocation. In certain embodiments, the power allocation in DCI via a first PDCCH can used to indicate a second PDCCH power. The second PDCCH transmission can be in a time window. The second PDCCH transmission can be before a timer expires. The second PDCCH transmission can be no less than X slots/symbols/frames/half frames/ms/us. If power allocation for PDCCH is present, the condition in implementation example 1 can be satisfied.

For a CSI-RS (e.g., for a periodic and/or semi-persistent CSI-RS), the power allocation for a CSI-RS can be indicated/configured by a DCI (e.g., via reusing existing DCI formats or newly defining a DCI format), or MAC CE. The power adjustment/indication can be applied for a CSI-RS resource, a set of CSI-RS resources, a list of CSI-RS-resource set, all the CSI-RS in one or more BWPs, a CSI-RS resource corresponding to a port, CSI-RS resources corresponding to one or more port, one UE, or a group of UEs. For example, a field in a DCI or MAC CE with N1 bits may indicate the power adjustment value/range for a CSI-RS. An actual power can be calculated based on power adjustment value/rang, together with parameter powerControlOffsetSS and ss-PBCH-BlockPower. Another field in DCI or MAC CE with N2 bits may indicate a corresponding CSI-RS resource ID, a CSI-RS resource set ID, a port number, a BWP ID, or a BWP set ID. The N2 size may be related to size of a list, including a number of ports in a list, a number of CSI resources in a list, a number of BWPs in a list, a number of CSI sets in a list, or a number of BWP sets in a list. N1 and N2 can be jointly coded.

For example, the following information can be transmitted by means of the DCI format X with a CRC scrambled by Y-radio network temporary identifier (RNTI): block number 1, block number 2 . . . block number N. Each block may contain/comprise a power information, which can be applied for a CSI-RS resource, a set of CSI-RS resources, all the CSI-RS in one or more BWPs, or CSI-RS resources corresponding to one or more port, one UE, or a group of UEs. In some embodiments, each block may contain/comprise an ID of a CSI-RS resource, a set of CSI-RS resources, a BWP, a BWP set, or a port number. Each block can be for one UE. The power information can be indicated in another block (e.g., the first block). In some embodiments, each block may contain/comprise a power allocation, an ID of a CSI-RS resource, a set of CSI-RS resources, a BWP, a BWP set, or a port number. One block can be indicated for one UE.

The power allocation/adjustment can be valid in X symbols/slots/frames/half frames/ms/us, or in Y CSI-RS resources (e.g., one CSI-RS in a period, multiple CSI-RS resources corresponds to multiple periods). The X or Y can be indicated in a field in the DCI or MAC CE or high layer. For example, the power of CSI-RS resources in X symbols/slots/frames/half frames/ms/us, or Y CSI-RS resources may be adjusted based on a signaling. The rest or other portion(s) may be adjusted according to powerControlOffsetSS. The power allocation can be valid before the UE receives a MAC CE or a DCI indicating that the power adjustment can be ended/released.

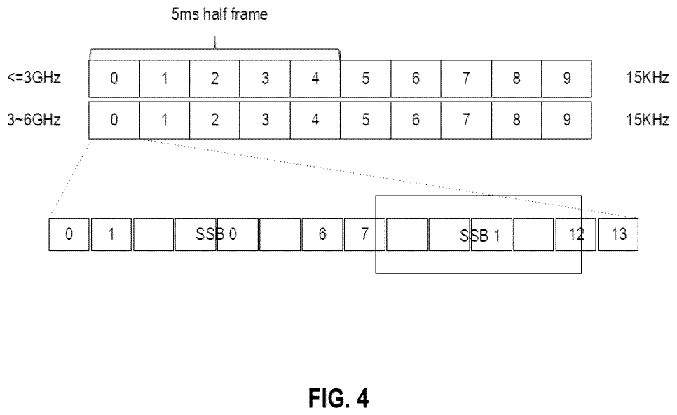

FIG. 4 illustrates a block diagram of an example synchronization signal block (SSB). For a SSB or a CSI-RS, the transmission can be muted. For example, the blocks labeled SSB 0 and SSB 1 can be a configured resource transmission. Some of the SSBs can be muted (e.g., not transmitted). In some embodiments, a SSB with a same starting symbol can be muted. A SSB with same slot number can be muted. A periodic pattern for a SSB can be defined and the periodic position may not transmit the SSB. The remaining SSBs can be still transmitted. Similar to a CSI-RS, a pattern can be defined to mute (e.g., inactivate/prevent) the CSI-RS transmission. The pattern for muting can at least be defined based on a periodicity. A transmission pattern can be different from a muted pattern. A periodic position (of a transmission pattern) that is not part of a muted pattern can support transmissions of SSBs. SSBs in the remaining positions/patterns (that are not part of the transmission pattern) are not transmitted.

In some embodiments, the signaling may comprise the power information; or activation or deactivation information; or muting information, for at least one downlink (DL) physical channel or signal. The signaling can be communicated/sent via a downlink control information (DCI). The DCI can be scrambled by a predefined or high layer configured radio network temporary identifier (RNTI) (e.g., C-RNTI, MCS-C-RNTI, P-RNTI, SI-RNTI, PS-RNTI, CI-RNTI, AI-RNTI, INT-RNTI); or DCI format 2_3, 2_4, or 2_6 can be reused for the DCI or a new DCI format can be defined for the DCI.

In some embodiments, the power information, or activation or deactivation information, or muting information, for at least one downlink (DL) physical channel or signal, can be signaled via a downlink control information (DCI). The DCI may contain a plurality of blocks at least some of which may have a same or different size, each of the blocks having a plurality of bits, or a plurality of indication/indicator at least some of which may have a same or different size, each of the blocks having a plurality of bits. Each of the blocks/indication/indicator may comprise at least one of: power information, activation or deactivation information, muting information, or an identifier (ID) of a CSI-RS resource, a set of CSI-RS resources, a BWP, a BWP set, or a port number.

For the starting position of a first block of the plurality of blocks, it can be determined by a medium access control control element (MAC CE) signaling, or a higher layer signaling. The signaling may comprise activation information in MAC CE or DCI. The activation information may comprise whether a DL channel/signal transmission is activated or resources of the at least one DL physical channel or signal is activated. For example, after sending/receiving the activation information, the gNB may send/UE may receive the corresponding DL channels/signals. After sending/receiving the activation information, the gNB may send/UE may receive the corresponding DL channels/signals and the remaining part cannot be transmitted/received for the UE. The DL channels/signals may refer to a SSB or a CSI-RS.

The signaling may comprise deactivation information in MAC CE or DCI. The deactivation information may comprise whether a DL channel/signal transmission is deactivated or resources of the at least one DL physical channel or signal is deactivated. For example, after sending/receiving the deactivation information, the gNB may send/UE may not receive the corresponding DL channels/signals. After sending/receiving the deactivation information, the gNB may not sent/UE may receive the corresponding DL channels/signals and the remaining part can be transmitted/received for the UE. The DL channels/signals may refer to a SSB or a CSI-RS.

The signaling may comprise muting information in a MAC CE or a DCI. The muting information may comprise whether a DL channel/signal transmission is muted or resources of the at least one DL physical channel or signal is muted. The muting information may comprise a periodicity and/or an offset for muting. The DL channels/signals may refer to a SSB or a CSI-RS. For example, the transmission of a SSB/CSI-RS resource/CSI-RS resource set/SSB set corresponding to the same starting symbol and/or a periodicity can be muted. The remaining parts can be transmitted. For example, the transmission of SSB/CSI-RS resource/CSI-RS resource set/SSB set corresponding to the same slot number and/or a periodicity can be muted. The remaining parts can be transmitted.

In some embodiments, a UE may send a signaling, including a report or a feedback. The UE may send the information according to a DL channel/signal. A SSB may comprise a PSS, a SSS, a DMRS, or a PBCH. A PDCCH may comprise a DMRS for a PDCCH. A PDSCH may comprise a DMRS for a PDSCH or a PT-RS for a PDSCH.

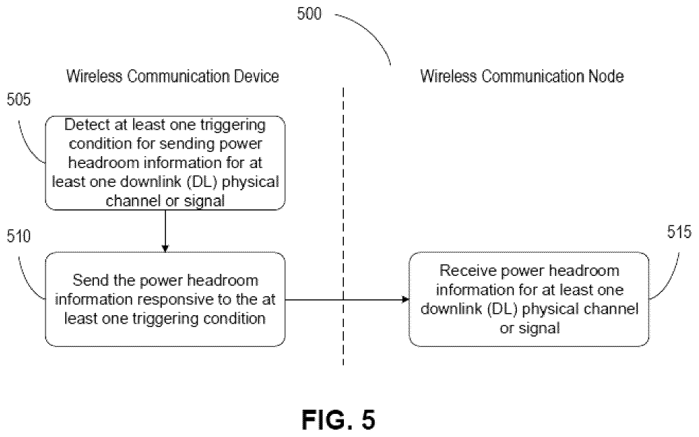

FIG. 5 illustrates a flow diagram of a method 500 for downlink power control. The method 500 may be implemented using any one or more of the components and devices detailed herein in conjunction with FIGS. 1-4. In overview, the method 500 may include detecting, by a wireless communication device (e.g., UE), at least one triggering condition for sending power headroom information for at least one downlink (DL) physical channel or signal (operation 505). The method may include sending, by the wireless communication device to a wireless communication node, the power headroom information responsive to the at least one triggering condition (operation 510).

In some embodiments, the at least one triggering condition may comprise at least one of: the wireless communication node operating below a maximum output power; or a power of a received DL channel or signal is larger than a threshold value, where the threshold value is determined at least by one of: a modulation and coding scheme (MCS) index table, a MCS, a modulation, another DL channel or signal, a downlink control information (DCI) signaling, a medium access control control element (MAC CE) signaling, or a higher layer signaling; or a defined downlink reference signal is absent or configured, or the corresponding configuration is present or absent, the defined downlink reference signal including a synchronization signal block (SSB), a primary synchronization signal (PSS), a secondary synchronization signal (SSS), or a channel state information reference signal (CSI-RS); or a DL channel or signal is indicated, configured or scheduled with at least one of: a modulation order, a power, a code rate, a transmit block size (TBS), a port, a layer number, or one or more codewords; or the wireless communication device is in connected mode; or the wireless communication device receiving from the wireless communication node a DCI scrambled by a predetermined radio network temporary identifier (RNTI).

In some embodiments, the at least one triggering condition may comprise: receiving from the wireless communication node a signaling, the signaling comprising a downlink control information (DCI) signaling, a medium access control control element (MAC CE) signaling, or a higher layer signaling. The signaling may comprise/indicate at least one of: a timer, a time window, or a periodicity. The wireless communication device may send the power headroom information according to the periodicity, timer and/or time window. The wireless communication device may receive the DL channel or signal with the periodicity for sending the power headroom information.

In some embodiments, the at least one triggering condition may comprise: the wireless communication node indicating that the wireless communication node is entering or in a network power saving mode. The network power saving mode may comprise: a sleep mode, the sleep mode comprising at least one of: a deep sleep mode, a light sleep mode, or a macro sleep mode; and/or a transition time, from a plurality of transition times corresponding to different network power saving modes.

In some embodiments, the at least one DL channel or signal may include at least one of: a physical downlink control channel (PDCCH), a demodulation reference signal (DMRS) for the PDCCH, a physical downlink shared channel (PDSCH), a DMRS for the PDSCH, a phase tracking reference signal (PT-RS) for the PDSCH, a synchronization signal block (SSB), a primary synchronization signal (PSS), a secondary synchronization signal (SSS), a DMRS for a physical broadcast channel (PBCH), a PBCH, a channel state information reference signal (CSI-RS), or a positioning reference signal (PRS). The triggering condition for sending power headroom information for PDCCH may comprise at least one of: (the wireless communication device receiving) a PDCCH that may include a downlink control information (DCI) for sending power headroom information, scrambled by a radio network temporary identifier (RNTI), a PDCCH that can be configured by a higher layer signaling for sending power headroom information, with at least one of: a search space (SS) identifier (ID) or a control resource set (CORESET) ID, a PDCCH that can be transmitted in X symbols or slots or a time duration, wherein X or the time duration is predefined or configured by a higher layer or DCI signaling, or a PDCCH that is received with largest power, or is received before expiration of a timer, wherein the timer can be predefined or configured by a higher layer or DCI signaling.

In some embodiments, the triggering condition for sending power headroom information for PDSCH may comprise at least one of: (the wireless communication device receiving) a PDSCH with a corresponding PDCCH that includes a downlink control information (DCI) scrambled by a radio network temporary identifier (RNTI) for sending power headroom information, a PDSCH with a corresponding PDCCH that can be configured by a higher layer signaling for sending power headroom information, with at least one of: a search space (SS) identifier (ID) or a control resource set (CORESET) ID, a PDSCH with a corresponding PDCCH, or the PDSCH itself, that can be transmitted in X symbols or slots or a time duration, wherein X or the time duration can be predefined or configured by a higher layer or DCI signaling, a PDSCH with a corresponding PDCCH, or the PDSCH itself, can be received before expiration of a timer, wherein the timer can be predefined or configured by a higher layer or DCI signaling, a PDSCH that can be scheduled using semi-persistent scheduling (SPS), a PDSCH that may carry a medium access control control element (MAC CE) signaling, or a PDSCH scheduled with a predetermined modulation order or a predetermined modulation and coding scheme (MCS) index table.

In some embodiments, the triggering condition for sending power headroom information for SSB may comprise: (the wireless communication device receiving) a SSB associated with a SSB index that can be indicated, predefined or configured by higher layer signaling, a SSB associated with a SSB set that can be indicated, predefined or configured by higher layer signaling, a SSB in X symbols or slots or a time duration, wherein X or the time duration can be predefined or configured by a higher layer or DCI signaling, a SSB in a half frame, or a SSB in a period.

In some embodiments, the triggering condition for sending power headroom information for PRS may comprise: (the wireless communication device receiving) a PRS associated with an indicated, predefined or configured PRS resource set, a PRS associated with an indicated, predefined or configured PRS resource, a PRS in X symbols or slots or a time duration, wherein X or the time duration can be predefined or configured by a higher layer or DCI signaling, or one or more PRS in a period or cycle.

In some embodiments, the wireless communication device may receive a configuration via a higher layer signaling, a medium access control control element (MAC CE) signaling, a non-access stratum (NAS) signaling, or a signaling from the wireless communication node, wherein the configuration may indicate a period of time for sending the power headroom information. The wireless communication device may send the power headroom information during the period of time to the wireless communication node. The wireless communication device may send the power headroom information for the at least one DL physical channel or signal in the period of time to the wireless communication node. The period of time may comprise: one or more cycles for a resource or resource set of the at least one DL physical channel or signal; a time window; X symbols or slots or a time duration, wherein X or the time duration can be predefined or configured by a higher layer or DCI signaling; or X ms, us, frames or half frames, wherein X can be predefined or configured by a higher layer or DCI signaling.

In some embodiments, the power headroom information may comprise a value or range or set (of values) for a power headroom of the at least one DL physical channel or signal, wherein the value or range or set can be based on an absolute value, or an offset or relative value. In some embodiments, the power headroom information may comprise at least one of: an identifier (ID) of a control resource set (CORESET) or a CORESET pool, an ID of a serving cell, an ID of a bandwidth part (BWP), an index of a sub-band, a modulation and coding scheme (MCS), an indication of whether time division multiple access (TDMA) or frequency division multiple access (FDMA) can be implemented, a slot number, a frame number, an index of a synchronization signal block (SSB), a cycle position, an ID of a resource set or a resource of a PRS, CSI-RS, or SSB, an ID of a search space or a search spaces set, an identifier (ID) of a bandwidth part (BWP) set, wherein the BWP set may include one or more BWPs, a port number, or a set of port number.

The wireless communication device may send, to the wireless communication node, the power headroom information via at least one of: a radio resource configuration (RRC) signaling, a medium access control control element (MAC CE) signaling, a non access stratum (NAS) signaling, a channel state information (CSI) report, a physical uplink control channel (PUCCH) signaling, an uplink (UL) channel or signal that may carry a hybrid automatic repeat request (HARQ) acknowledgement (ACK) or negative acknowledgement (NACK) message, a physical uplink shared channel (PUSCH) transmission, or user equipment (UE) assistance information.

Referring now to operation (515), a wireless communication node (e.g., a ground terminal, a base station, a gNB, an eNB, a repeater, or a serving node) may receive power headroom information for at least one downlink (DL) physical channel or signal from a wireless communication device (e.g., UE). The power headroom information can be sent to the wireless communication node responsive to at least one triggering condition for sending the power headroom information.

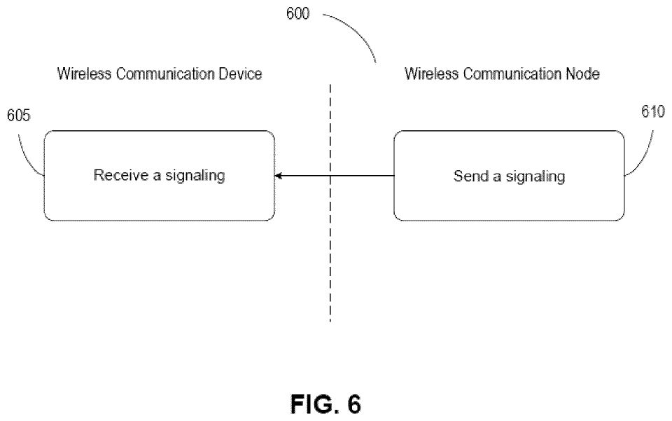

FIG. 6 illustrates a flow diagram of a method 600 for dynamic power control. The method 600 may be implemented using any one or more of the components and devices detailed herein in conjunction with FIGS. 1-4. In overview, the method 600 may include receiving, by a wireless communication device from a wireless communication node, a signaling (operation 605). The signaling may comprise power information, or activation or deactivation information, or muting information, for at least one downlink (DL) physical channel or signal. The signaling may comprise a downlink control information (DCI) signaling or medium access control control element (MAC CE) signaling. The DL physical channel or signal may include at least one of: a physical downlink control channel (PDCCH), a demodulation reference signal (DMRS) for the PDCCH, a physical downlink shared channel (PDSCH), a DMRS for the PDSCH, or a phase tracking reference signal (PT-RS) for the PDSCH, a synchronization signal block (SSB), a primary synchronization signal (PSS), a secondary synchronization signal (SSS), a DMRS for a physical broadcast channel (PBCH), a PBCH, a channel state information reference signal (CSI-RS), or a positioning reference signal (PRS).

The power information may comprise: a value or a value range or a value set which can be based on an absolute value, or an offset or relative value. The MAC CE or DCI signaling to indicate the power information may comprise: a field to indicate power information for the at least one DL physical channel or signal. The MAC CE or DCI signaling may comprise: another field to indicate an identifier of a channel state information reference signal (CSI-RS) resource, an identifier of a CSI-RS resource set, a port number, a port number set, an identifier of a bandwidth part (BWP), or an identifier of a BWP set, for the at least one DL physical channel or signal.

In some embodiments, the MAC CE or DCI signaling may comprise: a joint coding to indicate the power information and corresponding physical resources, wherein the corresponding physical resources may include at least one of: a channel state information reference signal (CSI-RS) resource, a set of CSI-RS resources, a list of CSI-RS resource sets, all CSI-RS in one or more bandwidth parts (BWPs), a CSI-RS resource corresponding to a port, CSI-RS resources corresponding to one or more ports, one wireless communication device, or a group of wireless communication devices.

The DCI signaling may comprise at least one of: a plurality of blocks at least some of which may have a same or different size, each of the blocks having a plurality of bits, or a plurality of indication/indicator at least some of which may have a same or different size, each of the blocks having a plurality of bits, wherein each of the blocks/indication/indicator may comprise at least one of: power information, activation or deactivation information, muting information, or an identifier (ID) of a CSI-RS resource, a set of CSI-RS resources, a BWP, a BWP set, or a port number. The DCI can be scrambled by a predefined or high layer configured radio network temporary identifier (RNTI); or DCI format 2_3, 2_4, or 2_6 can be reused for the DCI or a new DCI format can be defined for the DCI. The DCI signaling may include a plurality of blocks, and a starting position of a first block of the plurality of blocks can be determined by a medium access control control element (MAC CE) signaling, or a higher layer signaling.

In some embodiments, the at least one DL physical channel or signal may comprise a periodic or semi-persistent CSI-RS. The power information for a physical downlink shared channel (PDSCH) transmission, a channel state information reference signal (CSI-RS), a physical downlink control channel (PDCCH) transmission, a positioning reference signal (PRS) or a synchronization signal block (SSB), can be applied: after the MAC CE or DCI signaling; k symbols, slots, half frames, frames, ms or us, after the MAC CE or DCI signaling, or before a timer expires, wherein the timer can be defined, configured or indicated by the DCI signaling, a higher layer signaling, or the MAC CE signaling; within X symbols or slots or a time duration, wherein X or the time duration can be predefined or configured by a higher layer or the DCI signaling or the MAC CE signaling.

In some embodiments, the signaling may comprise activation information which may comprise: an indication that the at least one DL physical channel or signal, or resources of the at least one DL physical channel or signal, may be (or is to be) received after activation, wherein the DL physical channel or signal may include at least one of: a channel state information reference signal (CSI-RS), or a synchronization signal block (SSB).

In some embodiments, the signaling may comprise deactivation information which may comprise: an indication that the at least one DL physical channel or signal, or resources of the at least one DL physical channel or signal, may not be (or is not to be) received after deactivation, wherein the DL physical channel or signal may include at least one of: a channel state information reference signal (CSI-RS), or a synchronization signal block (SSB).

The signaling may comprise muting information which may comprise: an indication that the at least one DL physical channel or signal, or resources of the at least one DL physical channel or signal, may be (or is to be) muted after receiving the muting information, wherein the DL physical channel or signal may include at least one of: a channel state information reference signal (CSI-RS), or a synchronization signal block (SSB).

At least one aspect is directed to a system, method, apparatus, or a computer-readable medium. Referring now to operation (610), a wireless communication node (e.g., a ground terminal, a base station, a gNB, an eNB, a repeater, or a serving node) may send a signaling to a wireless communication device. The signaling may comprise power information, or activation or deactivation information, or muting information, for at least one downlink (DL) physical channel or signals. The signaling may comprise a downlink control information (DCI) or medium access control control clement (MAC CE) signaling.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second clement in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
detecting, by a wireless communication device, at least one triggering condition for sending power headroom information for at least one downlink (DL) physical channel or signal; and
sending, by the wireless communication device to a wireless communication node, the power headroom information responsive to the at least one triggering condition.

2. The method of claim 1, wherein the at least one triggering condition comprises at least one of:
the wireless communication node operating below a maximum output power, or
a power of a received DL channel or signal is larger than a threshold value, where the threshold value is determined at least by one of: a modulation and coding scheme (MCS) index table, a MCS, a modulation, another DL channel or signal, a downlink control information (DCI) signaling, a medium access control control element (MAC CE) signaling, or a higher layer signaling, or,
a defined downlink reference signal is absent or configured, or the corresponding configuration is present or absent, the defined downlink reference signal including a synchronization signal block (SSB), a primary synchronization signal (PSS), a secondary synchronization signal (SSS), or a channel state information reference signal (CSI-RS); or
a DL channel or signal that is indicated, configured or scheduled with at least one of: a modulation order, a power, a code rate, a transmit block size (TBS), a port, a layer number, or one or more codewords, or
the wireless communication device is in connected mode, or
the wireless communication device receiving from the wireless communication node a DCI scrambled by a predetermined radio network temporary identifier (RNTI); or
wherein the at least one triggering condition comprises the wireless communication node indicating that the wireless communication node is entering or in a network power saving mode, and wherein the network power saving mode comprises:
a sleep mode, the sleep mode comprising at least one of: a deep sleep mode, a light sleep mode, or a macro sleep mode, or a transition time, from a plurality of transition times corresponding to different network power saving modes.

3. The method of claim 1, wherein the at least one triggering condition comprises:
receiving from the wireless communication node a signaling, the signaling comprising a downlink control information (DCI) signaling, a medium access control control element (MAC CE) signaling, or a higher layer signaling.

4. The method of claim 3, wherein the signaling comprises at least one of:
a timer,
a time window, or
a periodicity.

5. The method of claim 4, comprising:
sending, by the wireless communication device, the power headroom information according to the periodicity; or
receiving, by the wireless communication device, the DL channel or signal with the periodicity for sending the power headroom information.

6. The method of claim 1, wherein the at least one DL channel or signal includes at least one of:
a physical downlink control channel (PDCCH), a demodulation reference signal (DMRS) for the PDCCH,
a physical downlink shared channel (PDSCH), a DMRS for the PDSCH, a phase tracking reference signal (PT-RS) for the PDSCH,
a synchronization signal block (SSB), a primary synchronization signal (PSS), a secondary synchronization signal (SSS), a DMRS for a physical broadcast channel (PBCH), a PBCH,
a channel state information reference signal (CSI-RS), or
a positioning reference signal (PRS).

7. The method of claim 6, wherein the triggering condition for sending power headroom information for PDCCH comprises at least one of:
a PDCCH that includes a downlink control information (DCI) for sending power headroom information, scrambled by a radio network temporary identifier (RNTI),
a PDCCH that is configured by a higher layer signaling for sending power headroom information, with at least one of: a search space (SS) identifier (ID) or a control resource set (CORESET) ID,
a PDCCH that is transmitted in X symbols or slots or a time duration, wherein X or the time duration is predefined or configured by a higher layer or DCI signaling, or
a PDCCH that is received with largest power, or is received before expiration of a timer, wherein the timer is predefined or configured by a higher layer or DCI signaling.

8. The method of claim 6, wherein the triggering condition for sending power headroom information for PDSCH comprises at least one of:
a PDSCH with a corresponding PDCCH that includes a downlink control information (DCI) scrambled by a radio network temporary identifier (RNTI) for sending power headroom information,
a PDSCH with a corresponding PDCCH that is configured by a higher layer signaling for sending power headroom information, with at least one of: a search space (SS) identifier (ID) or a control resource set (CORESET) ID,
a PDSCH with a corresponding PDCCH, or the PDSCH itself, that is transmitted in X symbols or slots or a time duration, wherein X or the time duration is predefined or configured by a higher layer or DCI signaling,
a PDSCH with a corresponding PDCCH, or the PDSCH itself, is received before expiration of a timer, wherein the timer is predefined or configured by a higher layer or DCI signaling,
a PDSCH that is scheduled using semi-persistent scheduling (SPS),
a PDSCH that carries a medium access control control element (MAC CE) signaling, or
a PDSCH scheduled with a predetermined modulation order or a predetermined modulation and coding scheme (MCS) index table.

9. The method of claim 6, wherein the triggering condition for sending power headroom information for SSB comprises:
a SSB associated with a SSB index that is indicated, predefined or configured by high layer signaling,
a SSB associated with a SSB set that is indicated, predefined or configured by higher layer signaling,
a SSB in X symbols or slots or a time duration, wherein X or the time duration is predefined or configured by a higher layer or DCI signaling,
a SSB in a half frame, or
a SSB in a period.

10. The method of claim 6, wherein the triggering condition for sending power headroom information for PRS comprises:
a PRS associated with an indicated, predefined or configured PRS resource set,
a PRS associated with an indicated, predefined or configured PRS resource,
a PRS in X symbols or slots or a time duration, wherein X or the time duration is predefined or configured by a higher layer or DCI signaling, or
one or more PRS in a period or cycle.

11. The method of claim 1, comprising:
receiving, by the wireless communication device, a configuration via a higher layer signaling, a medium access control control element (MAC CE) signaling, a non-access stratum (NAS) signaling, or a signaling from the wireless communication node, wherein the configuration indicates a period of time for sending the power headroom information; and
sending, by the wireless communication device to the wireless communication node, the power headroom information during the period of time, or
sending, by the wireless communication device to the wireless communication node, the power headroom information for the at least one DL physical channel or signal in the period of time.

12. The method of claim 11, wherein the period of time comprises:
one or more cycles for a resource or resource set of the at least one DL physical channel or signal;
a time window;
X symbols or slots or a time duration, wherein X or the time duration is predefined or configured by a higher layer or DCI signaling; or
X ms, us, frames or half frames, wherein X is predefined or configured by a higher layer or DCI signaling.

13. The method of claim 1, wherein the power headroom information comprises a value or range or set for a power headroom of the at least one DL physical channel or signal, wherein the value or range or set is based on an absolute value, or an offset or relative value.

14. The method of claim 1, wherein the power headroom information comprises at least one of:
an identifier (ID) of a control resource set (CORESET) or a CORESET pool,
an ID of a serving cell,
an ID of a bandwidth part (BWP),
an index of a sub-band,
a modulation and coding scheme (MCS),
an indication of whether time division multiple access (TDMA) or frequency division multiple access (FDMA) is implemented,
a slot number,
a frame number,
an index of a synchronization signal block (SSB),
a cycle position,
an ID of a resource set or a resource of a PRS, CSI-RS, or SSB,
an ID of a search space or a search spaces set,
an identifier (ID) of a bandwidth part (BWP) set, wherein the BWP set includes one or more BWPs,
a port number, or
a set of port number.

15. The method of claim 1, comprising:
sending, by the wireless communication device to the wireless communication node, the power headroom information via at least one of:
a radio resource configuration (RRC) signaling,
a medium access control control element (MAC CE) signaling,
a non access stratum (NAS) signaling,
a channel state information (CSI) report,
a physical uplink control channel (PUCCH) signaling,
an uplink (UL) channel or signal that carries a hybrid automatic repeat request (HARQ) acknowledgement (ACK) or negative acknowledgement (NACK) message,
a physical uplink shared channel (PUSCH) transmission, or
user equipment (UE) assistance information.

16. A wireless communication device, comprising:
at least one processor configured to:
detect at least one triggering condition for sending power headroom information for at least one downlink (DL) physical channel or signal; and
send, via a transmitter to a wireless communication node, the power headroom information responsive to the at least one triggering condition.

17. A method comprising:
receiving, by a wireless communication node from a wireless communication device, power headroom information for at least one downlink (DL) physical channel or signal,
wherein the power headroom information is sent to the wireless communication node responsive to at least one triggering condition for sending the power headroom information.

18. A wireless communication node, comprising:
at least one processor configured to:
receive, via a receiver from a wireless communication device, power headroom information for at least one downlink (DL) physical channel or signal,
wherein the power headroom information is sent to the wireless communication node responsive to at least one triggering condition for sending the power headroom information.
